(19) United States
(12) Patent Application Publication
(10) Pub. No.: US 2024/0115358 A1
(43) Pub. Date: Apr. 11, 2024

(54) EASY TO ATTACH DENTAL IMPLANT AND THE PROCESS THEREOF

(71) Applicant: Kamil Karroum, LAWRENCEVILLE, GA (US)

(72) Inventor: Kamil Karroum, LAWRENCEVILLE, GA (US)

(21) Appl. No.: 17/963,667

(22) Filed: Oct. 11, 2022

(51) Int. Cl. A61C 8/00

(52) U.S. Cl. CPC A61C 8/0068

(57) ABSTRACT

A dental attachment (100) comprising a top unit (104); and a bottom unit (106). The bottom unit (106) is designed to receive the top unit (104) through a screwing mechanism to overall fix the dental attachment (100) into the alveolar bone of the jaw of a patient. Further, a system enabling easy installation of dental implants on a patient, the system comprising a plurality of multi-unit abutments (102) designed to fix into an alveolar bone of the jaw of the patient; an dental attachment (100) placed over the plurality of multi-unit abutments (102); a layer of a soft liner (302) placed above the plurality of multi-unit abutments (102) and the dental attachment (100); and a denture (304) specially designed to fit upon the layer of the soft liner (302).

### BACKGROUND

### Field of the Invention

Embodiments of the present invention generally relate to dental implantation and particularly to an implant

### Description of Related Art

Tooth loss is a very common problem that made dental implants a common practice. Tooth loss can happen as a result of disease and trauma therefore, the use of dental implants to provide support for the replacement of missing teeth has a long and multifaceted history.

A major advance in dentistry has been the successful replacement of lost natural teeth by osseointegrated implants. Years of clinical experience have fostered a consensus regarding many of the placement criteria and techniques to maximize the chance for long-term implant stability and function. The use of dental implants for the oral rehabilitation of fully and partially edentulous patients has greatly broadened the scope of clinical dentistry, creating additional treatment options in complex cases in which functional rehabilitation was previously limited or inadequate. The predictability and long-term success of dental implants have been well documented, both in removable and fixed prostheses.

Among various dental materials and their successful applications, a dental implant is a good example of the integrated system of science and technology involved in multiple disciplines including surface chemistry and physics, biomechanics, macro-scale to nano-scale manufacturing technologies, and surface engineering. As with many other dental materials and devices, there are crucial requirements taken upon on dental implant systems, since the surface of dental implants is directly in contact with vital hard/soft tissue and is subjected to chemical as well as mechanical bio-environments. Such requirements should, at least, include biological compatibility, mechanical compatibility, and morphological compatibility to surrounding vital tissues.

The previously documented references require the dentist to perform the whole process/surgery in three stages including the creation of space in the jaw bone, placement of the abutment, and finally placement of the crown. The traditional process takes place in stages and requires months to complete the whole process.

There is thus a need for a new technique and dental implants that overcome all the shortcomings of the existing solution.

### SUMMARY

Embodiments in accordance with the present invention provide an dental attachment. The dental attachment includes a top unit. The dental attachment further includes a bottom unit. The bottom unit is designed to receive the top unit through a screwing mechanism to overall fix the dental attachment into the alveolar bone of the jaw of a patient.

Embodiments in accordance with the present invention provide a system enabling easy installation of dental implants on a patient. The system includes a plurality of multi-unit abutments designed to fix into an alveolar bone of the jaw of the patient. The system further includes an dental attachment placed over the plurality of multi-unit abutments. The system further includes a layer of a soft liner placed above the plurality of multi-unit abutments and the dental attachment. The system further includes a denture specially designed to fit upon the layer of the soft liner.

Embodiments in accordance with the present invention further provide a method for enabling easy installation of dental implants on a patient. The method includes placing dental attachment over the plurality of multi-unit abutments fixed into the alveolar bone of the jaw of a patient; placing a surgical denture over the dental attachment using a surgical guide or a standard method; sealing the gaps and holes in between the denture and gingival tissues using a layer of the soft liner.

Embodiments of the present invention may provide a number of advantages depending on its particular configuration. First, embodiments of the present application provide a dental fitment device and a method for enabling easy installation of dental implants on a patient using the dental fitment device.

Next, embodiments of the present application provide a procedure for uploading temporary dentures that don't need bone reduction.

Next, embodiments of the present application provide a dental fitment device that locks the denture with a very strong retention. and can be removed for cleaning.

Next, embodiments of the present application provide a dental fitment device that enables easy fixing and removal allowing the patients to have a normal bite during the healing process and avoiding gingiva infections.

Next, embodiments of the present application provide a method that enables the denture to be uploaded on the same day of surgery.

Next, embodiments of the present application provide a method that takes around 15 minutes for fixing the denture in the place of missing teeth.

Next, embodiments of the present application provide a method that is 100% accurate because it is relined over the implant with soft material.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF THE DRAWINGS

The above and still further features and advantages of embodiments of the present invention will become apparent upon consideration of the following detailed description of embodiments thereof, especially when taken in conjunction with the accompanying drawings, and wherein:

FIG. 1A illustrates a diagram depicting a dental attachment, according to an embodiment of the present invention;

FIG. 1B illustrates a diagram depicting the dental attachment fitted over a multi-unit abutment, according to an embodiment of the present invention;

FIG. 2 illustrates an exploded view of the top unit and the bottom unit of the dental attachment, according to an embodiment of the present invention;

FIG. 3 depicts a system enabling easy installation of dental implants on the patient according to an embodiment of the present invention; and

FIG. 4 depicts a flowchart of a method for enabling easy installation of dental implants on a patient, according to another embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise.

### DETAILED DESCRIPTION

The following description includes the preferred best mode of one embodiment of the present invention. It will be clear from this description of the invention that the invention is not limited to these illustrated embodiments but that the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

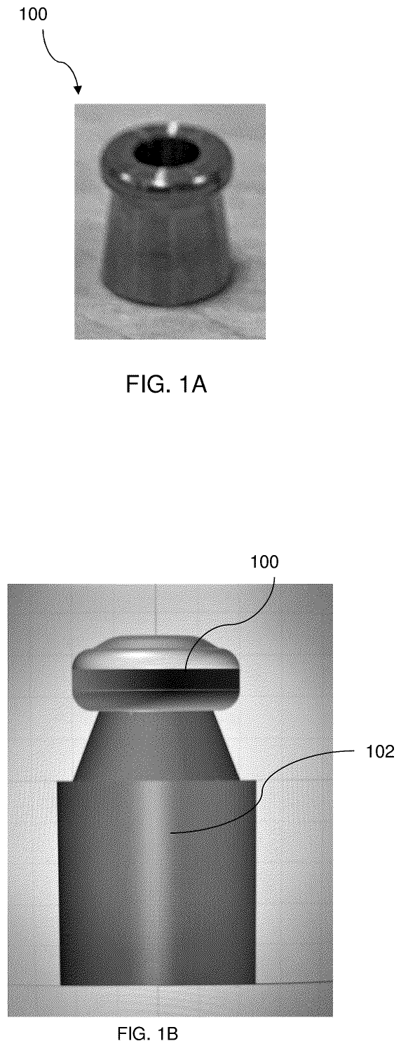

FIG. 1A illustrates a diagram depicting a dental attachment n dental attachment 100, according to embodiments of the present invention. The dental attachment 100 may be designed to be placed over a plurality of multi-unit abutments 102a-102n (as shown in FIG. 1B). According to an embodiment of the present invention, the plurality of multi-unit abutments 102a-102n (hereinafter referred to as multi-unit abutments 102) may be designed to fix into an alveolar bone of the jaw of a patient. The multi-unit abutments 102 may be fixed into the alveolar bone of the jaw of the patient through a surgical operation. In an exemplary scenario, an oral surgeon exposes the alveolar bone by cutting the gums with small instruments and drilling holes into the bone. Afterward multi-unit abutments 102 is positioned into the bone, which functions as the tooth's root. The multi-unit abutments 102 may be made up of a material, but not limited to, a titanium, a gold alloy, a stainless steel, a cobalt-chromium alloy, a nickel-chromium alloy, and so forth. Embodiments of the present invention are intended to include or otherwise cover any type of the material including known, related art, and/or later developed technologies.

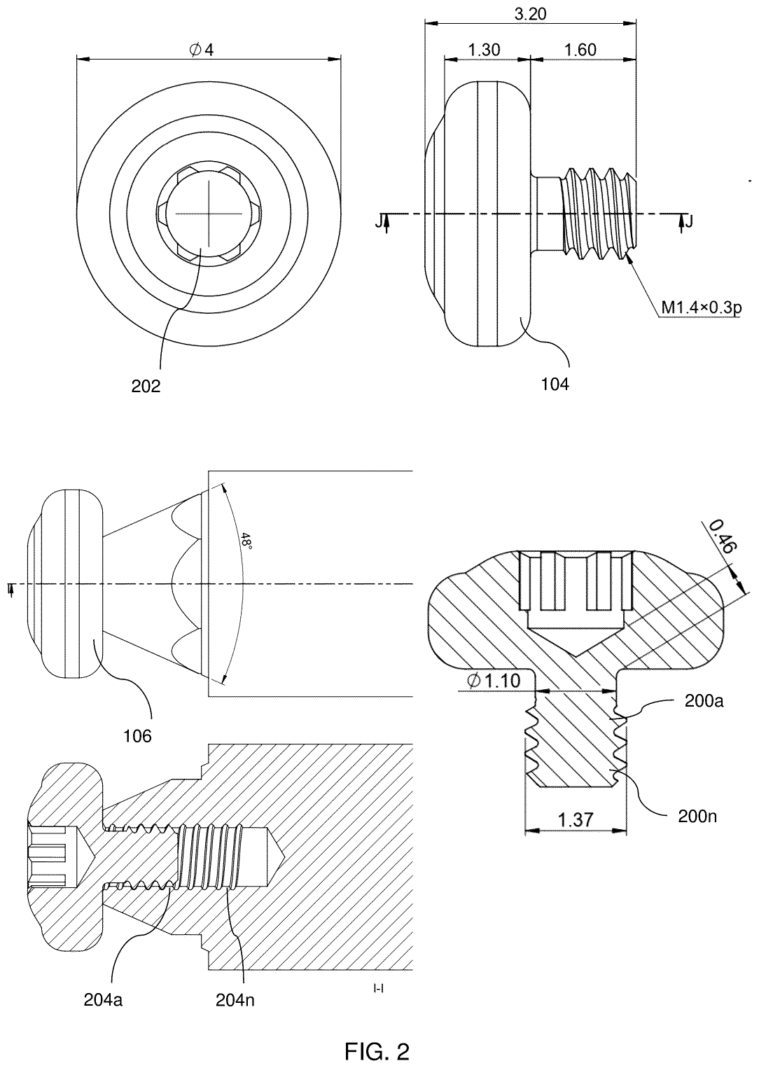

According to embodiments of the present invention, the dental attachment 100 may be made up of a material, but not limited to, a titanium, a gold alloy, a stainless steel, a cobalt-chromium alloy, a nickel-chromium alloy, and so forth. Embodiments of the present invention are intended to include or otherwise cover any type of the material including known, related art, and/or later developed technologies. The dental attachment 100 comprises a top unit 104 and a bottom unit 106. Further, the top unit 104 and the bottom unit 106 will be explained in detail in conjunction with FIG. 2.

FIG. 2 illustrates an exploded view of the top unit 104 and the bottom unit 106 of the dental attachment 100, according to embodiments of the present invention. The top unit 104 may be designed in the shape of a screw that may be screwed upon the bottom unit 106 using a proper screwing tool. The top unit 104 may be made up of a material, but not limited to, a titanium, a gold alloy, a stainless steel, a cobalt-chromium alloy, a nickel-chromium alloy, and so forth. Embodiments of the present invention are intended to include or otherwise cover any type of the material including known, related art, and/or later developed technologies.

According to an embodiment of the present invention, a distal end of the top unit 104 has a plurality of female threads 200a-200n. In a preferred embodiment of the present invention, at least three female threads 200a-200n (hereinafter referred to as female threads 200) are designed on the distal end of the top unit 104. Further, the distal end of the top unit 104 has a diameter of 1.37 centimeters (cm). According to an embodiment of the present invention, a proximal end of the top unit 104 has a screwing hole 202. Furthermore, the proximal end of the top unit 104 has a diameter of 4 centimeters (cm). According to embodiments of the present invention, the overall length of the top unit 104 from the distal end to the proximal end sums up to 3.20 centimeters (cm) out of which the proximal end is 1.60 cm and the distal end is 1.30 cm.

The bottom unit 106 may be designed to receive the top unit 104. The bottom unit 106 comprises a plurality of male threads 204a-204n. The male threads 204a-204n (hereinafter referred to as male threads 204) may be disposed of upon a proximal end of the bottom unit 106. According to embodiments of the present invention, the distal end of the bottom unit 106 may be designed as a frustum. The shape may help the dental attachment 100 to snap fit the multi-unit abutment 102.

According to embodiments of the present invention, the bottom unit 106 may be made up of, a material, but not limited to, a titanium, a gold alloy, a stainless steel, a cobalt-chromium alloy, a nickel-chromium alloy, and so forth. Embodiments of the present invention are intended to include or otherwise cover any type of the material including known, related art, and/or later developed technologies.

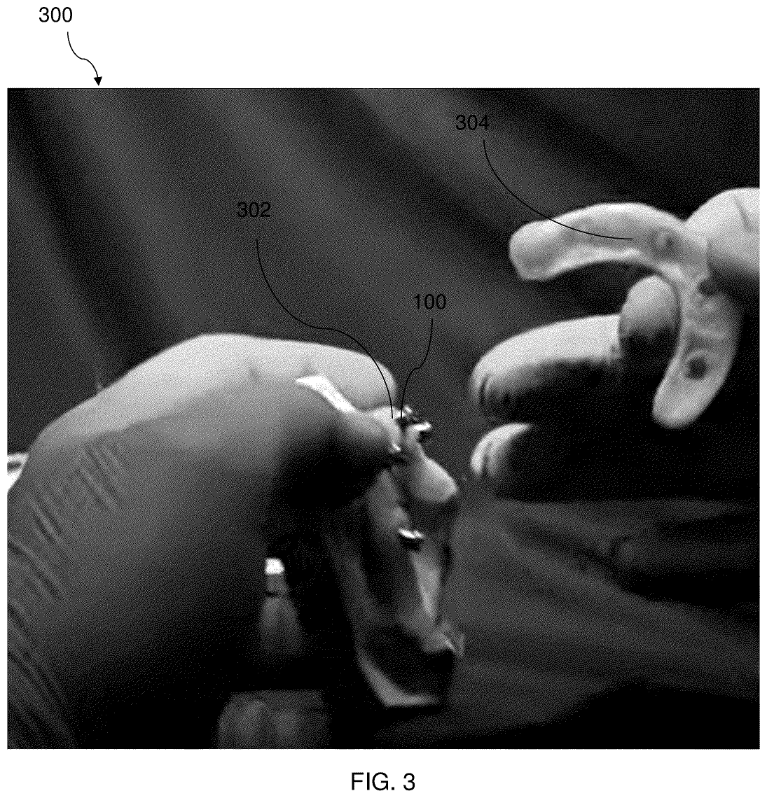

FIG. 3 depicts a system 300 enabling easy installation of dental implants on the patient, according to embodiments of the present invention. The system 300 comprises the dental attachment 100, the multi-unit abutments 102, a layer of a soft liner 302, and a denture 304.

As discussed in FIGS. 1A and 1B the dental attachment 100 may be placed over the multi-unit abutments 102 that may be designed to be fixed to the alveolar bone of the jaw of the patient. Further, the layer of soft liner 302 may be filled into the gaps and holes in between the denture 304 and gingival tissues of the jaw of the patient. According to embodiments of the present invention, the soft liner 302 may be configured to absorb shock between the hard base of the denture 304 and the gingival tissues of the jaw of the patient. The layer of soft liner 302 may be used when creating new dentures 304, according to an embodiment of the present invention. The layer of soft liner 302 may be used when reling into existing dentures 304, according to another embodiment of the present invention.

Further, the denture 304 are removable false teeth. According to embodiments of the present invention, the denture 304 may be made of, but not limited to, an acrylic, a plastic, a nylon, a metal, a gold, and so forth. Embodiments of the present invention are intended to include or otherwise cover any type of the material including known, related art, and/or later developed technologies.

According to embodiments of the present invention, the denture 304 may be designed to fit snugly over the dental attachment 100 disposed of in the gingival tissues of the jaw of the patient to replace missing teeth. The denture 304 may be designed according to the size, and alignment of the teeth of the patient which may vary from patient to patient.

Further, the system 300 comprising the dental attachment 100 significantly increases accuracy while reducing the time for immediate loading. This innovative system 100 makes dental implants and/or denture 304 a high-quality & time-efficient process.

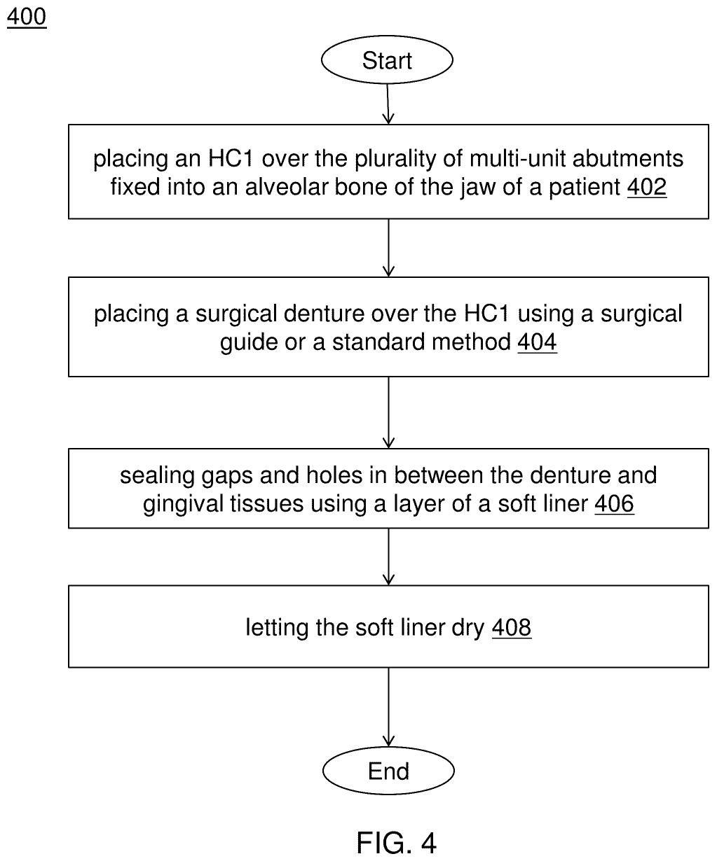

FIG. 4 depicts a flowchart of a method for enabling easy installation of dental implants on a patient, according to embodiments of the present invention.

At step 402, placing dental attachment 100 over the plurality of multi-unit abutments 102 fixed into the alveolar bone of the jaw of the patient. The dental attachment 100 may be screwed over the plurality of multi-unit abutments 102 fixed into the alveolar bone of the jaw of a patient using the screwing tool.

At step 404, a surgical denture may be placed over the dental attachment 100 using a surgical guide or a standard method.

At step 406, the gaps and holes in between the denture 304 and gingival tissues may be sealed using a layer of the soft liner 302. The soft liner 302 may be configured to provide a cushion thus acting as a shock absorber between the hard base of the denture 304 and the gingival tissues of the jaw.

At step 408, the soft liner 302 may be left untouched to dry up and complete the whole molding process.

Further, the patient leaves the surgery in less time with a better-fitting temporary denture, increasing the patient's comfort through the process explained above in FIG. 4. The process reduces the patient's chair time, allowing the doctor to serve more patients.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any devices or systems and performing any incorporated methods. The patentable scope of the invention is defined in the claims and may include other examples that occur to those skilled in the art. Such other examples are intended to be within the scope of the claims if they have structural elements that do not differ from the literal language of the claims, or if they include equivalent structural elements with substantial differences from the literal languages of the claims.

I/We claim:

1. A dental attachment (100) comprising:
a top unit (104); and
a bottom unit (106);
wherein the bottom unit (106) is designed to receive the top unit (104) through a screwing mechanism to overall fix the dental attachment (100) into the alveolar bone of the jaw of a patient.

2. The dental attachment (100) as claimed in claim 1, a distal end of the top unit (104) has a plurality of female threads (200a-200n).

3. The dental attachment (100) as claimed in claim 2, wherein at least three female threads (204a-204n) are designed on the distal end of the top unit (104).

4. The dental attachment (100) as claimed in claim 1, the distal end of the top unit (104) has a diameter of 1.37 centimeters (cm).

5. The dental attachment (100) as claimed in claim 1, a proximal end of the top unit (104) has a screwing hole (204) that is screwed into the bottom unit (106) using a screwing tool.

6. The dental attachment (100) as claimed in claim 1, the proximal end of the top unit (104) has a diameter of 4 centimeters (cm).

7. The dental attachment (100) as claimed in claim 1, the overall length of the top unit (104) is 3.20 centimeters (cm).

8. The dental attachment (100) as claimed in claim 1, wherein male threads (204a-204n) are disposed upon a proximal end of the bottom unit (106).

9. The dental attachment (100) as claimed in claim 1, the top unit (104) is made up of, a material such as, a titanium, a gold alloy, a stainless steel, a cobalt-chromium alloy, a nickel-chromium alloy, or a combination thereof.

10. The dental attachment (100) as claimed in claim 1, the bottom unit (106) is made up of, a material such as, a titanium, a gold alloy, a stainless steel, a cobalt-chromium alloy, a nickel-chromium alloy, or a combination thereof.

11. A system enabling easy installation of dental implants on a patient, the system comprising:
a plurality of multi-unit abutments (102) designed to fix into an alveolar bone of the jaw of the patient;
a dental attachment (100) placed over the plurality of multi-unit abutments (102);
a layer of a soft liner (302) placed above the plurality of multi-unit abutments (102) and the dental attachment (100); and
a denture (304) specially designed to fit upon the layer of the soft liner (302).

12. The system as claimed in claim 11, wherein the layer of the soft liner (302) is configured to seal the gaps and holes in between the denture (204) and gingival tissues of the jaw of the patient.

13. The system as claimed in claim 11, the multi-unit abutments (102) are made up of, a material such as, a titanium, a gold alloy, a stainless steel, a cobalt-chromium alloy, a nickel-chromium alloy, or a combination thereof.

14. The system as claimed in claim 11, the soft liner (302) is made up of acrylic resin.

15. A method for enabling easy installation of dental implants on a patient, the method comprise:
placing an dental attachment (100) over the plurality of multi-unit abutments (102) fixed into the alveolar bone of the jaw of a patient;
placing a surgical denture over the dental attachment (100) using a surgical guide or a standard method;
sealing the gaps and holes in between the denture (304) and gingival tissues using a layer of the soft liner (302).

16. The method as claimed in claim 15, the method further comprises a step of letting the soft liner (302) dry.

17. The method as claimed in claim 15, the step of placing the dental attachment (100) over the plurality of multi-unit abutments (102) fixed into the alveolar bone of the jaw of a patient further involves tightening of the dental attachment (100) using a screwing tool.
